(19) United States
(12) Patent Application Publication
(10) Pub. No.: US 2010/0137170 A1
(43) Pub. Date: Jun. 3, 2010

(54) DUAL USE WELL TREATMENT COMPOSITION

(75) Inventors: Beth Ann Wolf, Hutchinson, KS (US); Gene H. Zaid, Sterling, KS (US)

Correspondence Address: HOVEY WILLIAMS LLP, 10801 Mastin Blvd., Suite 1000, Overland Park, KS, 66210, US

(73) Assignee: JACAM CHEMICALS, LLC, Sterling, KS (US)

(21) Appl. No.: 12/327,733

(22) Filed: Dec. 3, 2008

(51) Int. Cl. C09K 8/532

(52) U.S. Cl. 507/236

(57) ABSTRACT

Stabilized sulfide control compositions for oil well and related uses are provided which include a first ingredient selected from the group consisting of tetra (hydroxymethyl) phosphine (THP) or a salt thereof (THPS) and an amino phosophono chelant. The compositions are stabilized against cold-weather crystal formation and deposition by the presence of a morpholine-based stabilizing agent. Preferred compositions include the sulfate salt of THP, diethylenetriamine penta (methylenephosophonic acid) sodium salt, and morpholine.

### BACKGROUND OF THE INVENTION

1. Field of the Invention

The present invention is broadly concerned with dual-use well treatment compositions containing tetra (hydroxymethyl) phosphine (THP) or a salt thereof (THPS) and an amino phosophono chelant. More particularly, the invention is concerned with such compositions and methods of use thereof wherein the compositions are stabilized against formation and deposition of crystals even during cold weather storage. The compositions of the invention serve as a bactericide, a corrosion inhibitor, and to dissolve metal sulfides in hydrocarbon recovery and processing systems.

2. Description of the Prior Art

Metal sulfide deposits, and especially iron sulfide, are a major source of economic loss in the oil industry. The deposits are mainly the result of a reaction between hydrogen sulfide, formed by sulfate-reducing bacteria, and ferrous metal oil field equipment and/or iron compound in the formation. They obstruct the flow of oil through wells and in the adjacent strata and also in pipelines and in processing and refinery plant. Ferrous sulfide particles also tend to stabilize oil water emulsions which often form, especially during secondary oil recovery, and present major problems to oil producers.

It is known that such metal sulfides can be removed by using strong acids. However, this method generates large volumes of highly toxic hydrogen sulfide gas, and is thus not an acceptable technique. Acrolein can also be used to dissolve sulfides, but this also presents severe health, safety and environmental problems.

U.S. Pat. No. 6,926,836 describes the use of compositions containing THP or THPS and amino phosophonate chelants for metal sulfide control. Such compositions are effective sulfide control agents in oil wells and other systems. However, it has been found that these compositions are very unstable, particularly in cold weather. Specifically, the compositions tend to fail owing to the deposition of large quantities of needle-shaped crystals. Such crystals can plug up injection pumps and other processing equipment in oil wells, leading to well failure and the need to shut down production to clean the clogged equipment.

There is accordingly a need in the art for improved and stabilized THP/THPS-chelate compositions which avoid the problem of crystal deposition during cold weather.

### SUMMARY OF THE INVENTION

The present invention overcomes the problems outlined above and provides stabilized three-component compositions. Broadly speaking, the compositions of the invention include a first ingredient selected from the group consisting of THP, THPS, and mixtures thereof as well as a quantity of an amino phosophono chelating agent. In order to provide composition stability and the essential elimination of crystal deposition, a sufficient amount of a morpholine-based stabilizing agent forms a part of the compositions. It has been found that use of such a stabilizing agent allows storage of the compositions for a period of at least about 10 days, more preferably at least about 30 days, and most preferably about 100 days, at 20° F. or lower.

The most preferred compositions of the invention include from about 2-20% by volume of the sulfate salt of THP, from about 1-20% by volume of diethylenetriamine penta (methylenephosophonic acid) sodium salt, and from about 0.1-25% by volume of morpholine. Additional ingredients including ethylene glycol and a non-ionic surfactant can also be used in the compositions.

The compositions may be added directly to circulating well fluids at a preferred level of from about 1-500 ppm for sulfide control, corrosion inhibition, and bacteria control.

### DETAILED DESCRIPTION OF THE PREFERRED EMBODIMENTS

The present invention provides stabilized THP/THPS-amino phosophono chelant compositions for introduction into oil wells or in other contexts requiring bactericidal and corrosion inhibition effects. The compositions are very resistant to formation of crystals even when stored over long periods in cold weather conditions. The improved compositions thus can be used in oil wells situated in cold climates without fear of plugging of pumps or other well equipment.

The preferred compositions include THP and/or THPS, an amino phosophono chelant, and a stabilizing agent selected from the group consisting of morpholine, morpholine derivatives, and mixtures thereof. The stabilizing agent has been found to essentially completely eliminate the formation of crystals, and also serves to maintain the compositions at an acidic pH.

### The THP/THPS Component

Standard THP can be used in the invention. However, in preferred forms, use is made of the salt form, THPS. The useful THP salts should be stable under acidic conditions, with the preferred salts being the sulfate, and Group VIIA salts (e.g., chloride, fluoride, and bromide), and mixtures thereof. Generally, this ingredient is selected from the group consisting of THP, THPS and mixtures thereof, should be present in the compositions at a level of from about 2-25% by volume, more preferably from about 5-15% by volume.

### Amino Phosophono Chelant

The amino phosophono chelant preferably has at least one and more preferably two or more amine nitrogen atoms and at least one and preferably more than one phosphono group.

Although the acid form of the chelant can be employed, the chelant is preferably an amino phosphonate. The latter may conveniently be a compound of the formula R¹R²NCH₂PO₃X₂ where each of R¹R², which may be the same or different, is an organic group and X is hydrogen or a cation such that the amino phosphonate is water soluble. In particular it is preferred that at least one of R¹, R² is a —CH₂PO₃X₂ group and the other is selected from CH₂PO₃X₂, (CH₂)ₙOH and [(CH₂)ₙNCH₂]ₘ CH₂PO₃X₂ where each n is independently 2 or 3 and m is from 1 to 5.

Particularly preferred are ethylenediamine tetrakis (methylene phosphonates) and diethylene triamine pentakis (methylene phosphonates). Also of use are, for example, amino tris (methylene phosphonate), ethanolamine bis (methylene phosphonates) and triethylene tetramine hexakis (methylene phosphonates) as well as mixtures of two or more of the above amino phosphonates.

It is preferred that X is an alkali metal, especially potassium or, most preferably, sodium, or ammonium. X may also be, for example an organic base such as an alkylamine or alkanolamine having a total of up to six carbon atoms.

The chelant should be present in the compositions of the invention at a level of from about 1-20% by volume, more preferably from about 2-10% by volume.

The proportion of the first ingredient to chelant may generally be from about 1:40 to 40:1 by weight, most usually about 1:30 to 30:1 especially about 1:20 to 20:1, more especially about 1:10 to 10:1, preferably about 1:5 to 5:1, more preferably about 1:4 to 4:1, most preferably about 1:2 to 2:1, typically about 1.5:1 to 1:1.5, e.g. 1:1.

### The Stabilizing Agent

The morpholine-based stabilizing agent is selected from the group consisting of morpholine and morpholine derivatives, and should be used in the compositions of the invention at a level to substantially prevent formation of crystals in the compositions. In general, the stabilizing agent should be capable of preventing essentially any crystal deposition in the THP/THPS-amino phosophono mixture for a period of at least about 10 days at 20° F., and more preferably for a period of at least about 30 days at such temperature.

In practice, the stabilizing agent is typically used at a level of from about 0.1-25% by volume, more preferably from about 0.5-10% by volume, and most preferably from about 1-5% by volume.

The preferred class of morpholine stabilizing agents is in accordance with the formula

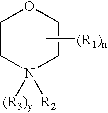

where n ranges from 1-4; each R₁ group is independently selected from the group consisting of H, C1-C6 alkyl, alkenyl, and cycloalkyl, C1-C6 primary and secondary amines, and C1-C6 alkoxy groups; each R₂ and R₃ is independently selected from the group consisting of H, O, and C1-C6 alkyl groups; and y is 0 or 1. The single most preferred stabilizing agent is morpholine, i.e., y is 0 and R₂ is H.

### Additional Ingredients

If desired, the compositions of the invention can be supplemented with various ingredients in order to facilitate storage and use of the compositions. For example, surfactants, buffering agents, and water soluble polymers can be employed. Another useful ingredient is an alkylene glycol, particularly ethylene glycol, to depress the freezing point of the compositions.

The glycol is typically used at a level of from about 5-60% by volune, more preferably from about 30-50% by volume. The surfactant, such as a nonylphenol ethoxylate, is used at minor levels, typically from about 0.01-0.5% by volume, more preferably from about 0.1-0.3% by volume. An exemplary polymer is an acrylic copolymer commercialized by Jacam Chemical Co of Sterling, Kans. under the designation WSI Polymer 7, used at a level of from bout 0.5-7% by weight, more preferably from about 1-3% by weight.

The compositions of the invention are blended as aqueous mixtures and have from about 10-65% by volume water, more preferably from about 25-50% by volume water. The pH of the compositions should be acidic, usually in the range of from about 3-7, more preferably from about 4-6.

The compositions of the invention can be used in all types of wells, such as producing, injection and disposal wells. In such uses the compositions are simply added to the well fluid, and are fully soluble therein. Typically, the compositions are used at levels to provide from about 1-500 ppm of the compositions, more preferably from about 5-50 ppm, and most preferably from about 10-20 ppm. The compositions serve several functions. The first is that of a bactericide, which is principally due to the presence of the THP/THPS component. This component also reacts in varying stoichiometrics and crystalline forms of metal sulfides (e.g., iron) to produce a soluble metal which can be removed from well fluid. The amino phosophono chelating agent provides good corrosion inhibition, and chelates with calcium, magnesium, strontium, and iron.

The compositions may also be used in any other hydrocarbon recovery or processing environment where the equipment includes surfaces subject to sulfide build-up and/or corrosion, for example in holding tanks or in oil or gas transmission lines. In these uses, the compositions can be directly added to the fluid in question, in order to allow the compositions to come into contact with such surfaces.

The following example sets forth presently preferred ingredients and methods of preparation for the compositions of the invention. It is to be understood, however, that this example is provided by way of illustration and nothing therein should be taken as a limitation upon the overall scope of the invention.

### EXAMPLE

The following ingredients were blended together in the listed order at ambient temperature conditions in a conventional blending device.

| Ingredient | Amount (% by volume) |
|---|---|
| Ethylene Glycol | 40.00 |
| Water | 10.00 |
| Amino Phosophono Chelant | 5.00 |
| Morpholine | 1.50 |
| Nonylphenol Ethoxylate Surfactant | 0.25 |
| THPS | 10.00 |
| Anionic Copolymer | 2.00 |
| Water | 31.25 |

The amino phosophono chelant employed was diethylenetriamine penta (methylenephosophonic acid) sodium salt commercialized by Jacam Chemical Co. of Sterling, Kans. under the designation JC3600W. The surfactant was a commercial product of the formula C₁₅H₂₄O(C₂H₄O)ₙ where n averaged about 12, marketed by Harcos Chemicals, Inc. under the designation T DET N12. The THPS employed was tetrakishydroxymethyl phosphonium sulfate, CAS#55566-30-8, distributed by Brenntag Southwest of Dallas, Tex. and Barton Solvents of Valley Center, Kans. The anionic copolymer was the WSI Polymer 7 described above. The pH of the final composition was about 5.0.

Extensive accelerated (−30° F. storage for three days) and field testing of this composition confirmed that it was virtually free of any detectable crystal formation even under the accelerated −30° F. testing. Also, the product has been stored under field conditions in the upper Midwest of the USA for long periods without crystal formation.

Additional morpholine derivatives were also tested in lieu of the morpholine in the above table, at the same amount (1.5% by volume) and by the accelerated −30° F. storage test. These derivatives were N-methylmorpholine, N-ethylmorpholine, N-methylmorpholine oxide, and N-aminopropylmorpholine. All of these derivataives gave satisfactory results, but for reasons of cost and availability, morpholine is preferred.

During the course of development of the present invention, a number of different ingredients were used in lieu of morpholine in THP/THPS-amino phosophono chelant compositions. None of these substitute materials were successful. For example, ingredients such as formaldehyde, methyl alcohol, thiodiglycolic acid, ammonium hydroxide, sodium hydroxide, and isopropyl alcohol were employed alone and in various combinations, and in each instance the product was prone to crystal deposition.

We claim:

1. A composition comprising:
a quantity of a first ingredient selected from the group consisting of THP, THPS, and mixtures thereof;
a quantity of an amino phosophono chelating agent; and
a sufficient amount of a morpholine-based stabilizing agent to prevent any substantial formation of crystals in the composition.

2. The composition of claim 1, said first ingredient being THPS.

3. The composition of claim 2, said THPS being tetrakis hydroxymethyl phosophonium sulfate.

4. The composition of claim 1, said first ingredient being present at a level of from about 2-20% by volume.

5. The composition of claim 1, wherein said chelating agent has at least one amine nitrogen atom and at least one phosophono group.

6. The composition of claim 5, wherein said chelating agent is a compound of the formula R¹R²NCH₂PO₃X₂ where each of R¹R², which may be the same or different, is an organic group and X is hydrogen or a cation such that the amino phosphonate is water soluble.

7. The composition of claim 6, wherein said chelating agent is diethylenetriamine penta (methylenephosophonic acid) sodium salt.

8. The composition of claim 1, wherein said chelating agent is present at a level of from about 1-20% by volume.

9. The composition of claim 1, wherein the ratio of said first ingredient to said chelant ranges from about 1:40 to 40:1 by weight.

10. The composition of claim 9, wherein said ratio is from about 1:4 to 4:1.

11. The composition of claim 1, said stabilizing agent selected from the group consisting of compounds of the formula 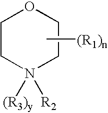
where n ranges from 1-4; each R₁ group is independently selected from the group consisting of H, C1-C6 alkyl, alkenyl, and cycloalkyl, C1-C6 primary and secondary amines, and C1-C6 alkoxy groups; each R₂ and R₃ is independently selected from the group consisting of H, O, and C1-C6 alkyl groups; and y is 0 or 1. The single most preferred stabilizing agent is morpholine, i.e., y is 0 and R₂ is H.

12. The composition of claim 11, said stabilizing agent being morpholine.

13. The composition of claim 1, wherein said stabilizing agent is present at a level such that the composition does not exhibit any substantial crystal formation after a period of storage of at least about 10 days at 20° F.

14. The composition of claim 13, said period being about 30 days.

15. The composition of claim 1, said stabilizing agent being present at a level of from about 0.1-25% by weight.

16. The composition of claim 1, said composition being aqueous and having a pH of from about 3-7.

17. A method of treating a well selected from the group consisting of oil and gas wells, injection wells, and disposal wells comprising the step of introducing a composition as defined in claim 1 into the well fluid of said well.

18. The method of claim 17, said composition being added to said well fluid at a level of from about 1-500 ppm.

19. The method of claim 18, said level being from about 5-50 ppm.

20. A method of treating hydrocarbon recovery or processing equipment having surfaces subject to build-up of metal sulfides and/or corrosion, comprising the step of contacting said surfaces with a composition as defined in claim 1.
